(19) United States
(12) Patent Application Publication
(10) Pub. No.: US 2016/0048879 A1
(43) Pub. Date: Feb. 18, 2016

(54) METHOD AND APPARATUS FOR SENDING PROMOTIONAL OFFERS

(71) Applicants: Fuad Aliyev Huseyn, Crumlin (IE); Azer Alakbarli Turgay, State College, PA (US)

(72) Inventors: Fuad Aliyev Huseyn, Crumlin (IE); Azer Alakbarli Turgay, State College, PA (US)

(21) Appl. No.: 14/458,975

(22) Filed: Aug. 13, 2014

(51) Int. Cl. G06Q 30/02

(52) U.S. Cl. CPC G06Q 30/0269; G06Q 50/01

(57) ABSTRACT

An apparatus including a server computer processor, and a server computer memory, in which the server computer processor is programmed by a computer program to collect user data from a plurality of users, concerning calendar dates which are special to one or more users, store the user data in the server computer memory, and provide merchant promotional deals to one or more users based on the user data. The merchant promotional deals may be provided via a client user interface to one or more users. The users may be notified about readiness of the merchant promotional deals by computer software application notifications which provide a link to a list of the merchant promotional deals. A method is also provided which includes preparing targeted merchant deals for a specific group of people using a computer processor based on user criteria, such as age, gender, language. nationality, and user's interests.

### FIELD OF THE INVENTION

This invention relates to improved methods and apparatus for sending promotional offers.

### BACKGROUND OF THE INVENTION

It is known for some merchants, such as restaurants or clothing brands, to offer discounts to individuals based on some of the individuals' special occasions such as birthdays, and national holidays. Merchants currently advertise these discounts via different advertising channels; investing the merchants' money on advertising of the discounts the merchants have, and/or the merchants create a database of their customers. The databases may collect customers' contact details for a long time in order to send the customers information about the merchants' promotional offers in the future. The last mentioned technique is limited to a particular merchant's existing customers and a merchant still needs to advertise its promotional offer or offers through different advertising/media channels in order to reach potential customers. There is not a centralized way, where all the data of users or customers (such as users' or customers' personal information, virtually all special days/occasions and their wishes/interests) are collected and different merchants can use that database to send their promotional offers to the right people in the right time, which includes both existing and potential customers, without using and investing in any other media platforms.

### SUMMARY OF THE INVENTION

One or more embodiments of the present invention provide a method, apparatus, and/or system for merchants to send promotional offers based on special days or dates for an individual. Special days, in the present application, may be defined, in at least one embodiment, as days people are more likely to buy some products or services. These special days or dates may include any important individual days or dates such as birthdays, wedding anniversaries, upcoming wedding days, engagement days, friends' birthdays, friends' anniversaries, vacation days taken from work etc. That also includes common special days/events celebrated in different countries and nationalities such as Christmas, Valentine's Day, Paddy's Day, Mothers' Day, Fathers' Day, Grandmothers' Day (Poland), Women's day (all post-Soviet countries), Nowruz Festival (many middle-east countries), Carnival (Brazil), Diwali (India), etc. One or more embodiments of the present invention allow merchants to offer personalized promotional offers to different nationalities living in the same country based on their national holidays/celebrations.

In addition to targeting special days for promotion of products and/or services, one or more embodiments of the present invention may also target specific age group, gender, location, nationality, or even language. One or more embodiments of the present invention may cause offers to be made for merchants' products and/or services to individuals in their first languages in order to be more effective and influential.

In addition, one or more embodiments of the present invention provide a point/level based system for users which differentiates between passive users and frequent/active users (the users who are more likely to buy/redeem a coupon than passive users). This point/level based system creates competition among merchants which encourages them to send better offers to higher level users since they are active and more likely to use the offers. In at least one embodiment users may get points by redeeming coupons, putting review/feedback after using the coupons and by inviting other people to join, which encourages them to use the system, apparatus or method while they do shopping on or for their special day. This feature also encourages users to put review/feedback after redeeming the coupons, which may inform other users and merchants about the quality of services they got, and also encourages users to invite their friends to join the system, apparatus or method. By collecting points, users advance to higher levels which allow them to get more discounts and better deals from the merchants in the future.

The example below illustrates how the point based system may work and all the details and numbers provided are a part of the example only and may be different in the future:

Users may get points in three ways in one example: (which can be adjusted in the future according to various needs of the company)
(a) Users may get one “Spoint” (where “Spoint” may be the name of a point that a user gets) for every euro/dollar or other currency they spend doing shopping where our voucher is used.
(b) Users may get fifty Spoints for each person signed up by their invitation.
(c)Users may get five Spoints when they provide review for their shopping experience.

Users are levelled by a certain amount of Spoints they get, which shows how proficient a user is. There may be six levels where upper levels are much harder to reach than the lower ones:

Level 1 may be “Beginner”.

Level 2 may be “Bronze user” (may be achieved by getting one hundred and fifty Spoints).

Level 3 may be “Silver user” (may be achieved by getting five hundred Spoints after the previous level).

Level 4 may be “Gold user” (may be achieved by getting one thousand five hundred Spoints after the previous level).

Level 5 may be “Platinum user” (may be achieved by getting four thousand five hundred Spoints after the previous level).

Level 6 may be “Diamond user” (may be achieved by getting ten thousand Spoints after the previous level).

Higher level users, in at least one embodiment, will have more advantages than lower level users, for example, they may get some additional amount of money off on their shopping which may be provided by a merchant or a group or entity running a system, apparatus or method in accordance with the present invention and/or or by a computer software program of an apparatus, method, and/or system of the present invention. One or more embodiments of the present invention provide a method of sending and/or offering deals for merchant's goods and/or services based on special days/occasions of people, including their own national days which may include using one central database and which in at least one embodiment allows merchants to get effective results out of their offers without announcing it through any paid advertising channels.

In one or more embodiments a method is provided of sending high targeted promotional deals, even considering aspects such as customer interests, wishes, demographics, first language, and nationality to improve a customer's shopping experience by using a better promotional deal platform.

Highly targeted advertising platforms may already be known in the prior art, such as Google (trademarked) advertisements and Facebook (trademarked) advertisements, but no highly targeted promotional offers platform exists.

One or more embodiments of the present invention can be implemented through any device that may have internet access (or any other type of network access to an application/web server) and a web browser or any app (computer application) platform, such as for example smartphones, tablet computers, personal digital assistant (PDA), Smart television TV, or even through a gaming computer that has internet access.

In at least one embodiment, merchants are charged by certain percentage of their revenue derived from redemption of their offers.

In at least one embodiment of the present application, an apparatus, system, and/or method is provided which includes and/or utilizes platforms such as a website, a web application or web computer software program, mobile apps or mobile/tablet computer application software programs (in any or all mobile platforms such as Android (trademarked), iOS (trademarked) Windows (trademarked) and Blackberry OS (trademarked)) and computer software applications or apps in different social media websites using their open APIs (application programming interfaces), such as a Facebook (trademarked) app or computer software application or Salesforce (trademarked) app or computer software application, connected to one database server.

In at least one embodiment of the present application, a user may register to use the method, apparatus, and/or system of one or more embodiments of the present invention through any of the platforms previously described, such as through a website, a mobile/tablet app or application computer program, or through apps, by inputting their individual personal information or details such as their name, username, email, phone, location city/town, first language, and possibly other personal details as shown in FIG. 7A. On the next page after registration, in at least one embodiment, an individual may input his or her special days based on day types suggested by the system as shown in FIG. 8. If an individual has a different special day which is not suggested by the system, that individual can include it in the “other” section as shown in FIG. 8. If a specific number of users input the same special day category in the “other” section, it will be approved by the system, be stored in computer memory, and the computer program will be reprogrammed to suggest such an added special day to new registered users when they input their own special days.

Individuals may also choose the time or time interval when they would like to get promotional offers from merchants for a specific special day as shown in FIG. 8. For example, after inputting his or her birthday or date, a user may identify how many days before his birthday he or she wants to start getting promotional deal notifications related to his or her birthday. Another example would be about the upcoming wedding day of a user. Here, the user may identify different time intervals when he would like to get offers (not only one time interval). This can be a time interval which may be one year, six months, and/or a few days before the wedding date. Upcoming special days have some exceptions on times of getting offers since different products or services should be required sufficiently long before the event.

One or more embodiments of the present invention also allow users to create a wish list for specific special days, which may include the categories of the offers they want to see and exact brand names that they want to get offers from. The system does not promise the users that they will get the offers which they have put in their wish lists. However one or more embodiments of the present invention create another targeting tool that merchants may use. For example, a female user may input in her wish list that she wishes to get offers from clothing brands as shown in FIG. 8. She also may identify a few clothing brands such as Moschino (trademarked) and Prada (trademarked). When the entity owning the brand Moschino (trademarked) wants to send special day deals to people, it can see how many people in the system inputted its name to their wish list, and send offers to them if it seems interesting to them. Also, the entity that owns Moschino (in this example) (trademarked) can see how many people put the category “clothing brands” or “luxury clothing brands” in their wish list. In the same order, if the number seems attractive to the brand, the brand can respond to those people's wishes and send its offers directly to them. This function provides merchants with a new targeting tool. Keywords or tags in a user wish list, which a user inputs using user programmable computing devices 112a to 112x of FIG. 1, are stored in the database server 234 of FIGS. 2 and 3, for particular users. They may include an industry or sector from where they want to get deals from (e.g. luxury brands, sportswear etc.), or particular brand names. When they include a particular brand name into their wish list, the application server 232 stores it in the database server 234 both as a particular brand name as it was inputted and as a category of that particular brand. For example, if Nike (trademarked) has been inputted by a user, the application server 232 may store that in two ways: (1) As a brand name Nike (trademarked); and (2) Categorizes the brand name and stores this as a “sportswear”. Categorizing the brand name allows merchants to target users based on their interests. So by this way, for example, a brand called Adidas (trademarked) which is also a sportswear brand may target users who inputted Nike (trademarked) into their wish list by targeting the category called “sportswear”. So, if the brand Adidas (trademarked) includes the tag or keyword of “sportswear” into its wish list targeting field or box 1022 shown in FIG. 10A, it will automatically target both the users who have inputted the keyword or tag “sportswear” into their wish list and the users who have inputted the keyword or tag of the brand “Nike” (trademarked) in their wish list. This happens because if a user inputs “Nike” (trademarked) into his/her wish list, the system understands that this particular user is interested in sportswear in general and may potentially buy something from other sportswear brands too. Application server 232 will have the list of brand names and their categories stored in the computer memory which will have been included by a group or entity running a system, apparatus or method in accordance with the present invention and/or or by a computer software program of an apparatus, method, and/or system of the present invention, before any user signs up. A wish list also allows merchants to target the users who are interested in a competitor brand or company. In general, when merchants target users more accurately by using wish list targeting, gender, age or other targeting tools (excluding special day targeting), it does not mean that the offers or promotional deals will be shown to only those users who are targeted. They are shown to all users based on their special days. These targeting tools allow the system to determine the order of a deals list 906 in FIG. 9 for each user, when they view them. It means that, more accurately targeted deals will be shown in higher positions than less accurately targeted deals. Being in a higher position in a deal list means that it will get more visibility by users and has more chance to be redeemed by a user, since the deals shown to users in deal lists begins from the top and users may view the other deals going down by a scroll bar if they wish to. Forming the order of deals/offers based on its targeting also provides a better quality order of deals for users and makes the system more attractive based on the logic “if a merchant targets you, then you are the one who may be interested in the offer”.

In at least one embodiment, users get notified by app notifications in their smartphones, social media app (computer application software) notifications on their social media account (e.g. they get notifications on their Facebook (trademarked) account from the Facebook app), email notifications and sometimes SMSs (short messaging services) which contain examples of offers and the link that refers to the full list of promotional deals.

In at least one embodiment of the present invention, after clicking a link in the notification or just clicking an app notification in a smartphone, users may be referred to a page on which will be shown a full list of promotional deals for their special day as shown in FIG. 8. Users may narrow the category of the offers by selecting the categories listed on the left side of the deals page as shown in FIG. 8. For example, a user may see one hundred deals from categories called “Entertainment”, “Health and beauty”, “Sports”, “Clothing brands”, “Restaurants”, and “Holiday packages”. He or she may select, check, or click on “Health and Beauty”, “Clothing Brands” and “Restaurants” categories to see the deals from these categories only, and to effectively eliminate the other categories. A user can select the deal that he or she is interested in, to view and request a coupon of the promotional offer.

Promotional offers can be percentage discounts on the whole shopping; can be a set amount discount coupon on the whole shopping or set price offer for a specific product or service.

In at least one embodiment, merchants may register in the system by using any of the platforms that the system uses, such as through website, mobile/tablet app (computer software application), or social media app (computer software application) by inputting their business details, such as the name of the company, address, business registration number, and other information; and open their own account.

In each merchant's account each merchant can see all the statistics related to their use of the system such as number of views/impressions, redeemed coupons in number and percentage, approved and disapproved notifications and their reasons, and forecast of the estimate number of redemptions as shown in FIG. 12.

In at least one embodiment, merchants may prepare and send offers to users by clicking the “New offer” button as shown in FIG. 10A. A new web page or software page is opened after a merchant clicks the “New offer” button as shown in FIG. 10A. In the new page as shown in FIG. 10A each merchant chooses the special days that they want to send the offer for. As each merchant chooses the type of special day, the system shows them the number of people that registered that special day. After choosing the main targets such as a special day and/or location, each merchant may also choose specific sub-targets as shown in FIG. 10A such as people's age and gender under the main target (all other sub-targets may be considered as a main target depending on a case). As merchants choose their sub-targets the system shows them the number of registered people for specific sub-targets based on a chosen special day and time period. The system also shows the total number of people that matches with all main and sub targets of merchants. After setting its targets, each merchant may input the details and explanation of their offers on the bottom of the page as shown in FIG. 10B. Each merchant may also include its requirements (if a merchant has any) for the offer (e.g. they may require identification as a proof of a user's birthday or nationality, or user's marriage certificate etc.), and the starting time or time period that the merchant wants to send the offers to the target as shown in FIG. 10B.

For example, the entity which owns the brand name “Zara” wants to send an offer of “20% off on anything purchased on your birthday” to users. The marketing executive for the brand, John, registers on a website (or on any other platform) in accordance with an embodiment of the present invention, and opens a merchant account as shown in FIG. 7B. After opening a brand's account, the marketing executive for the brand or company may click on to the “Add New Offer” button shown in FIG. 10A. In the opened web page or software page, the marketing executive may tick or select a target called “birthdays” from the provided list as shown in FIG. 10A. The system, apparatus, and/or method of at least one embodiment of the present invention may show that there are 150,000 (one hundred and fifty thousand) people who registered their birthday in the system. As one example, 70,000 (seventy thousand) of them may be male and 80,000 (eighty thousand) may be female. Also, in this example, 20,000 (twenty thousand) may be between the ages of sixteen and twenty-three, forty-thousand may be between twenty-four and thirty-six year of age, and so on. John, the brand marketing executive may choose the locations he wants to target; may choose both male and female; also may choose the age categories and other sub-targets provided by the system, as shown in FIG. 10A. After choosing his targets, John, the marketing executive for the brand, may input the offer details (main sentence, explanation, requirements etc.) in the boxes provided below the targeting part, as shown in FIG. 10B. After, the marketing executive John, chooses the date that he wants to start sending offers to birthday people, he may click or select the “Send the offer” button as shown in FIG. 10B. In at least one embodiment, all offers that are sent by merchants have to be approved by a group or entity running a system, apparatus or method in accordance with the present invention and/or or by a computer software program of an apparatus, method, and/or system of the present invention, before sending to users.

In at least one embodiment, an apparatus is provided comprising a server computer processor, and a server computer memory. In at least one embodiment, the server computer processor is programmed by a computer program to collect user data from a plurality of users, concerning calendar dates which are special to one or more users, store the user data in the server computer memory, and provide merchant promotional deals to one or more users based on the user data.

The merchant promotional deals may be provided via a client user interface to one or more users. The users may be notified about readiness of the merchant promotional deals by computer software application notifications which provide a link to a list of the merchant promotional deals.

The users may be notified about readiness of the merchant promotional deals by social media app notifications which provide a link to a list of the merchant promotional deals.

The users may be notified about readiness of the merchant promotional deals by email which provides a link to a list of the merchant promotional deals.

The users may be notified about readiness of the merchant promotional deals by a short message service which provides a link to a list of the merchant promotional deals.

The server computer processor may be programmed to provide a menu of a plurality of different predetermined special events, and to receive a user selection of one or more of the plurality of predetermined special events; wherein the server computer processor may be programmed to provide merchant promotional deals to one or more users based on the users selection of one or more of the plurality of predetermined special events.

The server computer processor may provide merchant promotional deals as a list displayed on a computer display to a user, wherein the list is targeted to the user such that a first deal of the merchant promotional deals is more prominent in the list than a second deal of the merchant promotional deals, if the first deal more closely matches a set of personal data for the user. The first deal may be more prominent in the list than the second deal by being higher in the list than the first deal.

In at least one embodiment, a method is provided comprising collecting user data from a plurality of users, concerning calendar dates which are special to one or more user, using a server computer processor, storing the user data in a server computer memory, and providing merchant promotional deals to one or more users based on the user data by use of the server computer processor.

In at least one embodiment a method is provided comprising preparing targeted merchant deals for a specific group of people using a computer processor based on user criteria. The user criteria may be age, gender, language, nationality, and user's interests.

### BRIEF DESCRIPTION OF THE DRAWINGS

FIG. 1 shows a block diagram of a plurality of user programmable computing devices, a plurality of merchant programmable computing devices, and a server computer for use in accordance with one or more embodiments of the present invention;

FIG. 2 is a block diagram of an apparatus, method, and/or system in accordance with an embodiment of the present invention;

FIG. 3 is a block diagram of an apparatus, method, and/or system of a data processing module which can be implemented, stored, and/or programmed by a merchant programmable computing device or computer and which is typically controlled and managed through a centralized the server computer;

FIG. 4 is a block diagram of a method for an example process of data entry by a user which can be implemented through a user programmable computing device, in accordance with an embodiment of the present invention;

FIG. 5 is a block diagram of an example process in accordance with an embodiment of the present invention of a merchant's deal preparation and management;

FIG. 6 is a block diagram of an example process of users' deal redemption in accordance with one or more embodiments of the present invention;

FIG. 7A shows a registration page displayed on a computer display of a user computer, such as a user computer smart phone, tablet or personal computer in accordance with one or more embodiments of the present invention;

FIG. 7B shows a registration page displayed on a computer display of a merchant computer, such as a merchant computer smart phone, tablet or personal computer in accordance with one or more embodiments of the present invention;

FIG. 8 shows a user's special day inputting page displayed on a computer display of a user computer, such as a user personal computer, smart phone or tablet in accordance with one or more embodiments of the present invention;

FIG. 9 shows a narrowing options of a user while viewing the page of deals on a computer display of a user computer, such as a user personal computer, smart phone or tablet in accordance with one or more embodiments of the present invention;

FIG. 10A shows a merchant promotional offer creator page displayed on a computer display of a merchant computer, such as a merchant personal computer, smart phone or tablet in accordance with one or more embodiments of the present invention;

FIG. 10B shows a second page of a merchant promotional offer creator page displayed on a computer display of a merchant computer, such as a merchant personal computer, smart phone or tablet in accordance with one or more embodiments of the present invention;

FIG. 11 shows an example of a merchant report center page displayed on a computer display of a merchant computer, such as a merchant personal computer, smart phone or tablet in accordance with one or more embodiments of the present invention; and

FIG. 12 shows an example of a merchant account statistics page displayed on a computer display of a merchant computer, such as a merchant personal computer, smart phone or tablet in accordance with one or more embodiments of the present invention.

### DETAILED DESCRIPTION OF THE DRAWINGS

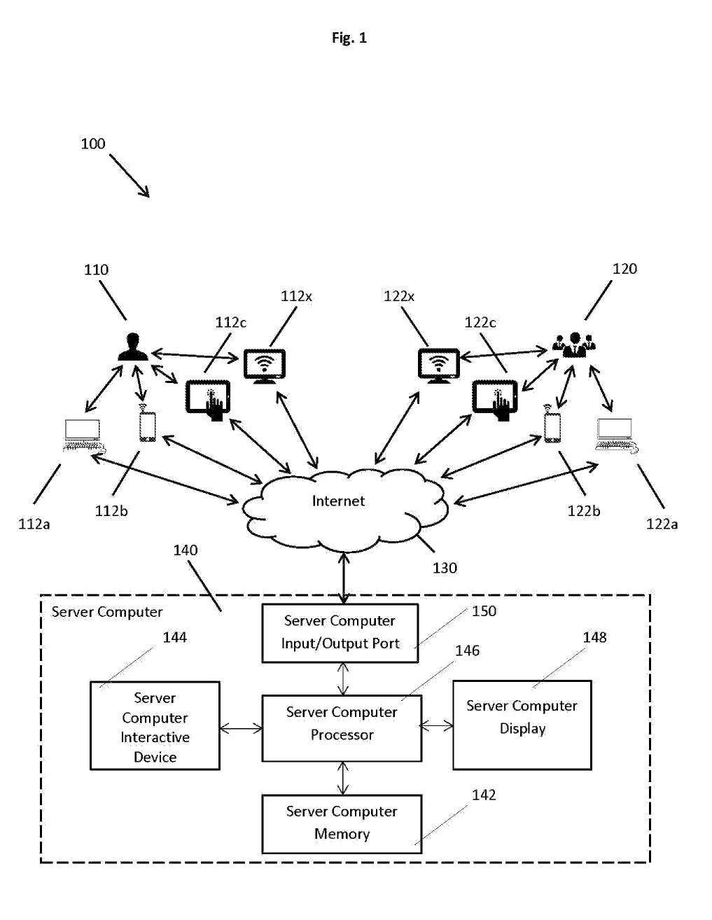

FIG. 1 shows a block diagram 100 of a plurality of user programmable computing devices or computers 112a, 112b, 112c, and 112x, a plurality of merchant programmable computing devices or computers 212a, 212b, 212c, and 212x, and a server computer 140 for use in accordance with one or more embodiments of the present invention.

The user 110 may be any person or customer that uses an apparatus, system, and/or method of one or more embodiments of the present invention or is likely to join the apparatus, system, and/or method of one or more embodiments through registering online, such as through one of computers 112a-112x. Each of the user programmable computing devices 112a-112x may be any electronic device that has access to internet 130 and/or to an internet browser or to any online computer application platform, such as for example iOS (trademarked) or Mac OS (trademarked),operating systems for computer devices manufactured by Apple Inc. (trademarked) Android (trademarked), Windows (trademarked), Blackberry OS (trademarked) and any other operating systems that include a software application platform (OS stands for operating system), via communications links, such as hardwired, software, wireless or any other type of known communications links; which has a computer display screen, an input device, a CPU (central processing unit or computer processor), an input/output port which may be connected or may communicate with the internet such as with internet 130, and a computer memory. Typically, a computer display screen or computer monitor or computer display is the part of a device that makes data and/or images appear on a screen. An input device or computer interactive device may include any machine that is capable, in any manner, to allow a user to input data into a computer, which includes but is not restricted to computer keyboards, including virtual keyboards, pointing devices, including computer mouse or touchpad, virtual mouse, and touchscreen displays. A CPU (Central Processing Unit) comprises processors and/or microprocessors of a programmable computing device where most calculations take place. An input/out port may include an interface on a computing device by which it may connect or communicate with the internet 130 via communications links, such as hardwired, wireless or any other type of known communications links. Computer memory may comprise permanent and/or temporary data storage of a programmable computing device or computer. The user computer processor (CPU) may communicate with the user computer display screen, the user computer memory, and the user computer input device. The user computer processor may implement computer software or program stored in the user computer memory Programmable computing devices may for example, include a personal computer or a laptop 112a, a smart mobile telephone or cell phone 112b, such as an iPhone (trademarked), a tablet computer 112c such as an iPad (trademarked), and any other electronic device that has access to internet 130 and/or to an internet browser or to any online application platforms 112x, such as PDAs (personal digital assistants), smart TVs, game consoles, kiosks and so forth.

FIG. 1 also shows a plurality of merchants 120 which may include any legal entity, which sells and/or provides any paid product and/or service, and which uses the apparatus, system, and/or method of one or more embodiments of the present invention or is likely to join the apparatus, system, and/or method through registering online in order to offer promotional deals to users using the one or more embodiments of the apparatus, method, and/or system. Each of the merchant programmable computing devices or computers 122a-122x may be any electronic device that has access to the internet 130 and/or to an internet browser or to any online application platform such as iOS (trademarked), Android (trademarked), Windows (trademarked), Blackberry OS (trademarked) and any other operating systems that include a software application platform via communications links, such as hardwired, software, wireless or any other type of known communications links; which has a display screen, an input device, a CPU (central processing unit or computer processor), an input/output port which may be connected or may communicate with the internet such as with internet 130, and computer memory. The merchant computer processor (CPU) may communicate with the merchant computer display screen, the merchant computer memory, and the merchant computer input device. The merchant computer processor may implement computer software or program stored in the merchant computer memory. Programmable computing devices may be for example, a personal computer or a laptop 122a, a smart mobile telephone or cell phone 122b, such as an Iphone (trademarked), a tablet computer 122c such as an Ipad (trademarked), and any other electronic device that has access to internet and/or to an internet browser or to any online application platforms 122x, such as PDAs, smart TVs, game consoles, and kiosks.

The server computer 140 may include server computer memory 142, a server computer interactive device 144, a server computer processor 146, a server computer display 148, and a server computer input/output port 150. The server computer memory 142, the server computer interactive device 144, the server computer input/output port 150, and the server computer display 148 communicate with the server computer processor 146 via communications links, such as hardwired, software, wireless or any other type of known communications links.

Each of the user programmable computing devices 112a-112x communicates with the server computer 140 via the internet 130 via communications links, such as hardwired, software, wireless or any other type of known communications links.

Each of the merchant programmable computing devices 122a-122x communicates with the server computer 140 via the internet 130 via communications links, such as hardwired, software, wireless or any other type of known communications links.

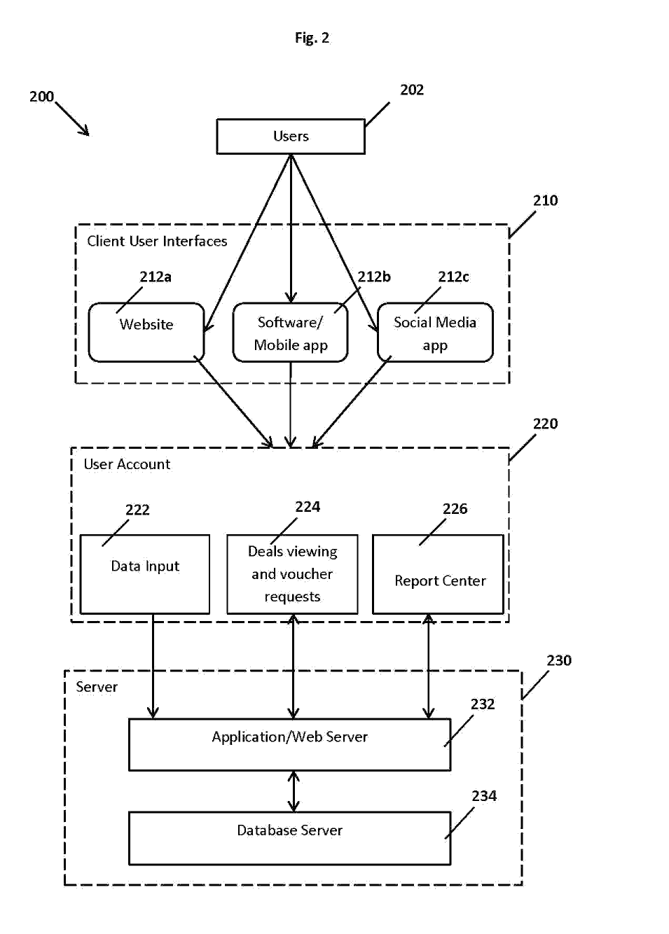

FIG. 2 is a block diagram of an apparatus, method, and/or system 200 in accordance with an embodiment of the present invention. The apparatus, method, and/or system 200 may include a plurality of users 202, client user interface or interfaces 210 which may include a website 212a, a computer software 212b or mobile application software 212b (hereinafter, “software/mobile app”), and/or a web application software which is created by using open API (application programing interfaces) of a third party social media website or software 212c (hereinafter, “social media app”). The apparatus, method, and/or system 200 may also include a server or server computer 230. The server or server computer 230 may include an application/web server 232 and a database server 234. Each of the users 202 may use one or more of the user programmable computing devices 112a-112x shown in FIG. 1A, in order to get access to client user interfaces 210 and one or more of its components 212a, 212b, and 212c. Users 202 can get access to a user account 220 through any of client user interfaces 210, such as through website 212a, software/mobile app 212b, and/or social media app 212c. The user account 220, and data concerning the user account 220 may be stored in computer memory of server 230, such as computer memory similar or identical to server computer memory 142 shown in FIG. 1

The user account 220 may include different parts, such as data input 222, deals viewing and voucher requests data 224, and report center data 226. Data input 222 is a section in the user account 220 where users 202 may input and/or change their personal information, such as their username, email, number, address, gender, special days. This data may then be stored in computer memory 142 of the computer server 230 and/or computer server 140.

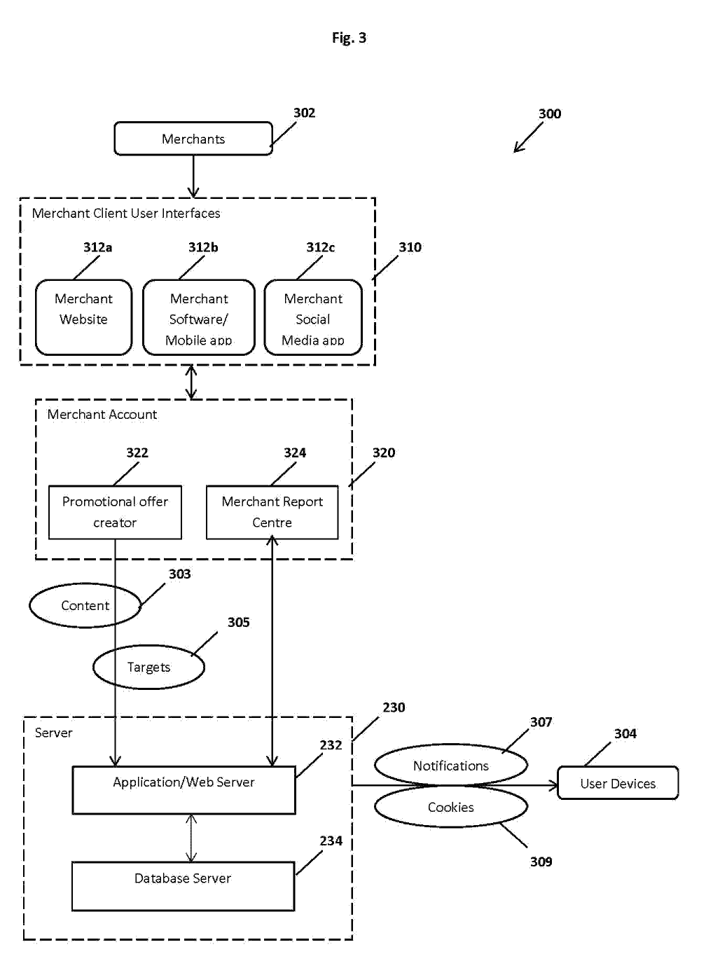

Deals viewing and voucher requests 224 is a section in the user account 220, which may be stored in server computer memory 142, and which users may access using one or more of user computing devices 112a-x, in order to view promotional offers they get from merchants 302 in FIG. 3 through application/web server 232, and to request sending online or offline vouchers of the promotional offers from application/web server or server computer 232.

The report center 226 is a section in the user account 220, which may be stored in computer memory of the server computer 230, and from which users 202 may request and access reports regarding, for example, a user's collected points, via a point based system, broken down by dates or time period, statistical information about how many people use the apparatus, system, and/or method of one or more embodiments of the present invention from that particular user's contact list, how many people registered in the system, how many people registered as a result of that particular user's invitation, and how many redemptions that particular user has made broken down by dates and time periods, and how much that particular user has saved using an apparatus, system, and/or method in accordance with an embodiment of the present invention.

The server or server computer 230 may be an apparatus, method, and/or system, which may include computer software and/or suitable computer hardware, that responds to requests across a network of programmable computer devices to provide, or help to provide, a network service. The server or computer server 230 may include an application/web server 232 and one or more database servers 234, each of which may be in one server computer or in a plurality of server computers. Application server computer 232 comprises a server computer with a computer program stored in computer memory, such as computer memory 142, which handles all computer application operations between users and databases. Web server 232 may be comprised of a server computer with a computer program that delivers web content, such as to user computing devices or computers 112a-x, which can be accessed through the Internet 130. Database server 234 comprises a server computer program stored in computer memory and implemented by a computer processor, which provides database services to other computer programs or computers. The term “Database server” 234, may also refer to a server computer dedicated to running such a computer program. Database server 234, in at least one embodiment, stores all the data provided by application/web server 232 and performs tasks such as data analysis, data storage, data manipulation, data archiving, and other non-user specific tasks based on the requests of the application/web server 232.

The web site 212a may be implemented and/or stored on the application/web server 232 of server side 230. The server 230 may be identical to the server computer 140 shown in FIG. 1A. A computer software program 212b or mobile application software program 212b may be implemented by and/or stored on the server 230 and/or the user programmable computing devices 112a to 112x. The social media app 212c may be a web application computer software program that is created by using open API (application programming interface) of a social media website or a computer software program such as Facebook (trademarked), or Salesforce (trademarked), and which may be implemented by and/or stored on the server computer 230.

The user account 220 and its parts 222, 224 and 226, may be accessed by users 202 through any one of client user interfaces 210 and/or any one of its components 212a, 212b and 212c. The user account 220 or data from the user account 220 may be displayed visually on a user computer display as part of the website 212a, the software/mobile app 212b, and/or the social media app 212c, where the users 202 may perform various operations and send requests to the application/web server 232.

Each of users 202 may register to use the method, system, and/or apparatus of one or more embodiments of the present invention by using any of his or her user programmable computing device 112a -112x in FIG. 1 to access the server computer 140 or the server 230 via the internet 130, using any of the platforms 212a-c (such as a website 212a, a software/mobile app 212b, or a social media app 212c) to create a user account 220, which may be stored in computer memory on the server computer 140 and/or the server 230.

FIG. 3 is a block diagram of an apparatus, method, and/or system 300 of data processing from a merchant side or from merchant programmable computing devices 122a-122x of FIG. 1, which is controlled and managed through the server 230. A merchant can register through any of the merchant programmable computer device 122a-122x, which may be for example a personal computer, tablet computer, or a smart phone, to use an apparatus, method, and/or system in accordance with an embodiment of the present invention. The merchant may enter business information using any of the components of the merchant client user interfaces 310, such as the merchant website 312a, computer software 312b or mobile application software 312b (hereinafter, “merchant software/mobile app”) , web application software which is created by using open API (application programing interfaces) of a third party social media website or software 312c (hereinafter, “merchant social media app”) as part of the process of registering and that may be stored on a server computer such as the database server 234 of the server 230 and/or server computer 140 shown in FIG. 1. A merchant website 312a and a user website 212a may be in a same internet domain name, but different URL (uniform resource locator) locations. After registering on the server 230 and/or the server computer in 140 shown in FIG. 1, merchants 302 get a merchant account 320 on the application/web server 232, which may be stored in server computer memory 142, through which they can make various transactions—such as prepare promotional offers for a product or service that they are selling through the promotional offer creator 322, check status of past promotions for products or services that they are selling, and request and view reports for their active and past promotional offers through merchant report center 324. Merchant account 320 may include but not be limited to parts such as promotional offer creator 322 and merchant report center 324, which may be stored on the server computer 230.

In a promotional offer preparation process, each of the merchants 302, may send requests to application/web server 232 by entering content 303 of promotional deals, and set targets 305 in the promotional offer creator 322 of the merchant account 320 via using any of the merchant programmable computer devices 122a-122x, via the internet 130 shown in FIG. 1, and via any of the components of the merchant client user interfaces 310, such as the merchant website 312a, merchant software/mobile application 312b, and merchant social media app 312c. After the application/web server 232 gets a request from one or more of merchants 302 and/or merchant programmable computer devices 122a to 122x, the application/web server 232 is programmed by computer software stored in computer memory of server 230 to send a request to the database server 234 in order to both store the provided information for merchants to use in the future and for reporting transactions, and to provide data of targeted users, which the notifications 307 will be sent to. Content 303 may include all information and pictures about the promotional deal for products and/or services which users will see on a computer display when viewing a deal on the user programmable computer device 112a to 112x. Merchants may target users or customers based on users' special day, age, gender, nationality and other known data in order to tell the server 230 which users the deals need to be sent to.

When setting a specific target, the application/web server 232 sends a request to the database server 234. The database server 234 is programmed by computer software to respond to the request by picking the users that match with a merchant's determined targets from its storage and/or server computer memory 142. After matching contents from merchants with merchants' targets, and comparing the accurateness of targets of different merchants for each user, the application/web server 232 creates special deal list for each user, which contains deals from different merchants that targeted their special days, and sorts those deals by accurateness of merchants' targeting for each user, where the most accurately targeted deal for a specific user gets the first position on a deal list, and the least accurately targeted deal gets the last position. The whole process happens each time a merchant creates a new offer and sets new targets, and those offers and targets are stored in the database server 234 and/or in the server computer memory 142 by the application/web server. The application/web server 232 then sends notifications 307 to one or more user devices of 112a-x at step 304 in order to notify and remind users that there are deals that they should look at. The application/web server 232 may send notifications 307 in a number of ways, such as: (a)software/app notifications which are triggered by software/mobile app 212b and which pop up on the display screen of one or more of the user programmable computer devices 112a-112x; (b) by email which users 202 can view by user programmable computing devices 112a-112x using the internet 130; (c) by notifications on social media profiles of users 202, such as Facebook (trademarked) profile or Salesforce (trademarked) profile, which is triggered by social media apps 312c and can be viewed by user programmable computing devices 112a to 112x using the internet 130; (d) by notifications on the user account 220 which can be viewed by users 202 by entering the user account 220 via any of the components of the client user interface 210, such as the website 212a, software/mobile application 212b, social media app 212c, using any of the user programmable computing devices 112a to 112x; (e) by SMS (short message service), using a bulk SMS sending computer software or computer programs, to user programmable computing devices 112a to 112x which have access to mobile computer networks. A bulk SMS sending computer software may be an existing computer software installed into the application/web server 232 which is programmed to send SMS notifications to a targeted user using programmable computing devices 112a-112x which have access to a mobile network, such as mobile smartphones, cell phones and tablet computers, by using the internet network 130.

After a user sees the deals being offered to him or her on the display screen of his or her user programmable computing device or devices of 112a-112x all of that user's behavior (such as views of deals, clicks on deals, redemptions etc.) is monitored through computer software stored on the server computer memory 142 and/or the storage of the database server 234 and implemented by the application/web server 232 and/or the user devices 304, each of which may be similar or identical to a user programmable computing device of devices 112a-112x, and sent back to the server 230 and and/or the server computer 140. The computer software, which is stored on the server computer memory 142 and/or the storage of the application/web server 232, may include cookies 309 that are sent to user devices 304 or user programmable computing devices 112a-112x. Cookies may include a web cookie which is to identify users 202, and the website settings on their next visits to the website 212a; and a persistent cookie, which is to identifying a user's interests by collecting information about a user's web surfing behavior or user preferences for a specific website with the purpose of possibly preparing a customized list of promotional offers and/or customized order of promotional offers in a list based on a user's interest. One or more web cookies may be or may include a small text file, given an ID (identification) tag that may be sent to a web browser of a user programmable computing device 112a to 112x by the application/web server 232 through the internet 130, and may be stored on a user device's browser directory or one or more user devices 112a-x. The user browser computer program of devices 112a-x is programmed to store the web cookies in text files on the user devices 112a-x. A message is then sent back to the server 230 through the internet 130 each time the user browser on one or more of devices 112a-x requests a web page from the application/web server 232. Persistent cookies are sent to a user programmable computing device 112a-112x by the application/web server 232 through the internet 130, which may be stored on a user device's web browser's subfolder and/or on a user device's hard drive on computing devices 112a-x. The persistent cookies may then send back information about a user's web surfing behavior, such as websites a user visits, web pages on those websites, time spent on those websites and/or web pages, theme of those websites and web pages, to the application/web server 232. All information sent to the application/web server 232 from cookies 309 are stored in the database server 234 or computer server memory 142, and used for serving better promotional offers and/or promotional offer listings to users 202.

All the statistical information regarding the behavior of users 202 related to the offered promotional deals, which is stored in the database server 234, is analyzed by the specific computer software, which is stored in the database server 234, by the request of the application/web server 232 which is based on the merchants' requests to the application/web server via the merchant report center 324 in the merchant account 320, and reported back to the merchants 302 in the merchant report center 324 of their merchant account 320 via merchant programmable computing devices 122a-122x.

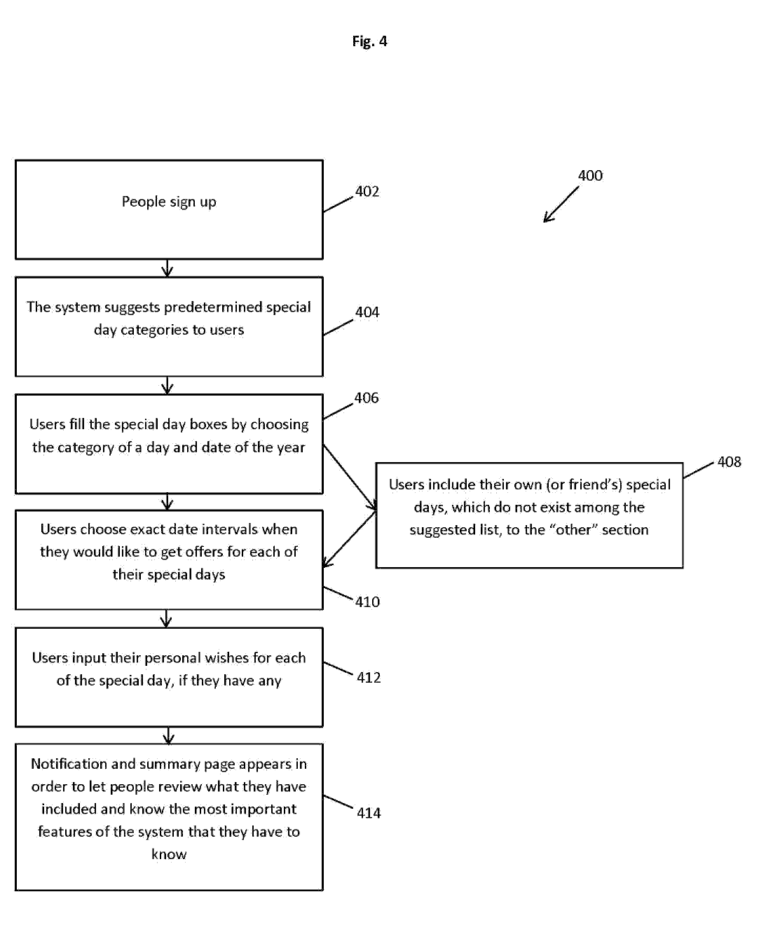

The database server 234 is programmed to analyze all the data regarding each promotional deal of each merchant when requested via report center 324. The functions of the report center 324 will be explained in more detail with reference to the description of FIG. 4. Merchants can view all this data through their merchant account 320, by using merchant programmable computing devices 122a to 122x.

FIG. 4 is a block diagram 400 of a method of data entry by a user using user programmable computing devices 112a to 112x of FIG. 1, in accordance with an embodiment of the present invention. The first step 402 in the process is for a user to sign up by inputting his or her details, by accessing client user interfaces 210 and/or any of its components, such as the website 212a, software/mobile application 212b, and social media app 212c via any of the user programmable computing devices 112a -112x. The user's details or personal information may include the user's name, login username to login to the method, apparatus, and/or system, gender, location, phone, first language, origin, marital status etc. The user's personal information or details are received by user programmable computing devices 112a to 112x which are programmed to send the personal information to the server computer 140 or 230 of FIG. 2 via internet 130. The personal details may be received by the server computer processor 146 via port 150 which may be programmed to store them in server computer memory 142 and/or database server 234.

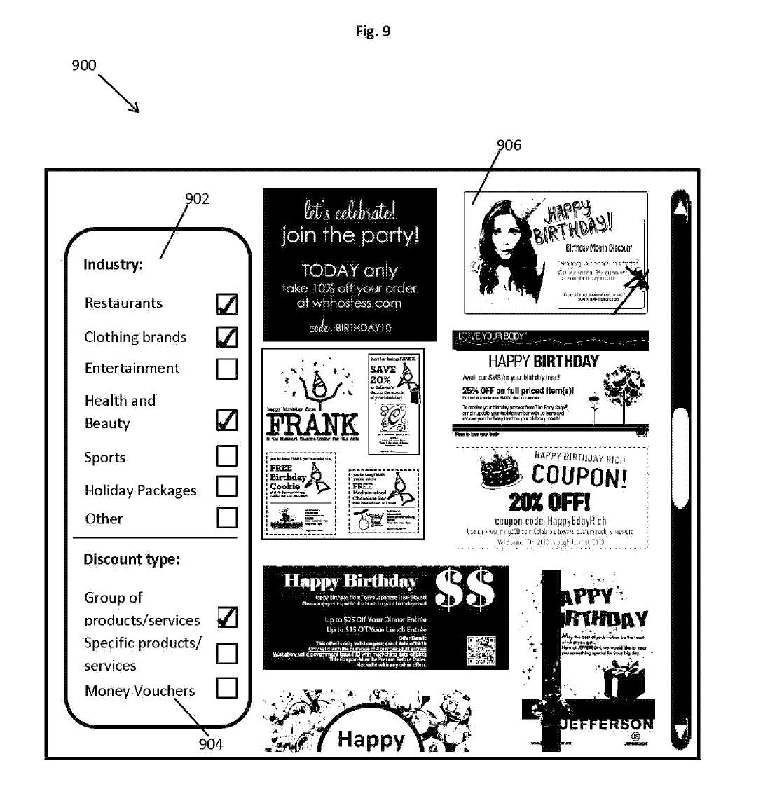

In the next step 404, the server computer 230 suggests special day categories to the user, such as by supplying suggestions to devices 112a-112x by the application/web server 232 which is programmed to suggest these categories based on computer software stored in the server computer memory 142 and user personal information stored in server computer memory 132 and/or the database server 234. These special day categories may be suggested by displaying them on the client user interfaces 210 and any of the components of the client user interface 210, such as the website 212a, software/mobile application 212b, and social media app 212c via the user programmable computing devices 112a-112x, based on web page or software pages that are downloaded and/or received from the server computer 140 and/or from the application/web server 232, and/or based on a software downloaded and/or received from the server computer 140 via internet 130. The categories that may be suggested may include the particular individual's birthday, anniversary, family members' or friends' birthdays, national holidays, upcoming wedding days, etc. These suggestions may be made in order to facilitate the data entry process for users as shown in FIG. 9.

At step 406 users choose, via computer interactive devices of the devices 112a-x, the special day categories that apply to them and include the day of a year for those categories by selecting this information and the selected information is set to the application/web server 232 and via application/web server 232 to the database server 234. In case the particular individual wants to include a special day category that is not in the list of special day categories, the particular individual can include that day into an “other” section as will be described for step 408. When users include a new special day into the system through the “other” section as shown in FIG. 9, they are notified by the server computer sending a message to one or more of devices 112a-x, that it might take more than a month in order to get their new special day approved since the system or application/web server 232 will check whether there will be a required amount of people who also add the same category to the “other” section. Thus, in at least one embodiment of the present invention, the server computer 140 and/or the application/web server 232 is programmed to wait a certain predetermined amount of time, to determine whether there is a demand for a new special day, by counting, and storing in computer memory, the number of requests for a specific new special day during a predetermined amount of time and determining whether meets the certain predetermined quota. If the number of requests for a specific new special day category during a certain predetermined amount of time meets the certain predetermined quota, the new special day category is allowed and/or approved automatically by the server computer 140 or application/web server 232 and/or manually by the administrator of the system. If a new special day category gets approved by the server computer 140 or application/web server 232 and/or manually by the administrator of the system, it will be suggested to other users as a special day category at the special day inputting stage.

After inputting their special days, a user can enter using user programmable computing devices 112a to 112x the time intervals when they want to get deal notifications for their special days 310 as shown in FIG. 9; and these will be sent to application/web server 232 which is programmed by a computer program to send a request to the database server 234 to store them in the database server 234. A user may choose these time intervals by using one or more of the client user interfaces 210 and any of the components of the client user interface 210, such as the website 212a, software/mobile application 212b, and social media app 212c provided by server computer 230 via the internet 130. A user may choose a time interval, in at least one embodiment, separately for each of the special days they included. This is because different time intervals may apply differently to different special day categories. For example, while the maximum time interval for a birthday can be any time interval between ten days before the date and the actual birthday, for an upcoming wedding day it may be different. A user may want to receive deal notifications even a year before the event for offers from event venues or/and six months before the event for wedding clothes as well as one month before the event for beauty salons etc. For the special day categories like this, the application/web server 232 may be programmed by computer software stored in the storage of the application server 232 to suggest a broad time interval options to users.

After users choose time intervals when they want to get offers for their special days, in at least one embodiment they get a chance to input their wishes or wish list for each of the special days separately at step 312. The wish list may be entered via user programmable computing devices 112a to 112x , through client user interfaces 210 and any of the components of the client user interfaces 210, such as the website 212a, software/mobile application 212b, and social media app 212c provided by application/web server via internet 130.

A user may include a brand name or product category or industry from where he or she would like to get offers in their wish list. A user may input it separately for each special day as shown in FIG. 9 because wishes for different special days may be different. For example, a user may want to get offers from a specific brand for his/her friend's birthday gift since his/her friend may like that brand, and/or may want to get offers from beauty salons for his/her friend's wedding. The application/web server 232 may notify users via user programmable computing devices 112a-112x , through the client user interfaces 210 and any of the components of the client user interface 210, such as the website 212a, software/mobile application 212b, and social media app 212c via internet 130 that the system does not guarantee that their wishes will be accomplished; however it may indicate that it will try its best to accomplish them.

At the last stage users may get a notification from the application/web server 232 via user programmable computing devices 112a to 112x, through the client user interfaces 210 and any of the components of the client user interfaces 210, such as 212a, 212b, and 212c via internet 130 that they may include new special days or change them any time with a warning message that most of the merchants will ask about validation of their special day by various methods, such as ID (identification) card, marriage certificate etc. The users may be notified, in at least one embodiment, that they will not get bothered by any deal notifications unless it is the time interval they chose for a specific special day. They will be promised that the system will try its best to send highly relevant deals especially designed for their special days and interests. Also, they will be informed about the point based system, the ways of earning points, and how they will use them. They will also be informed about the rules of inputting their friends' special days (e.g. they can input their friends' special days only by inviting them to register in the system in order to validate the given information).

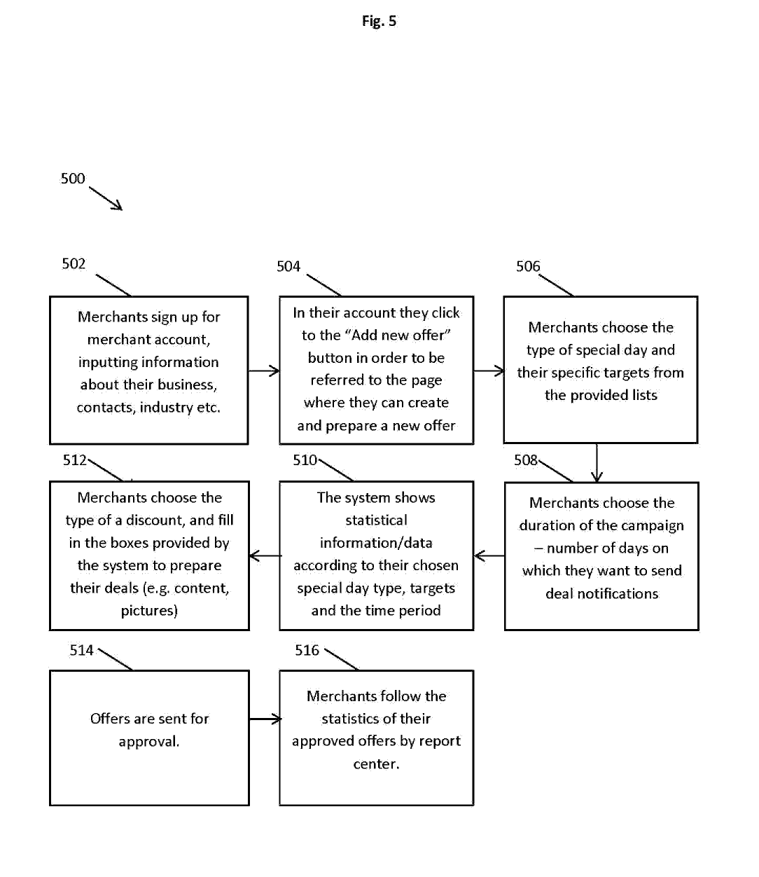

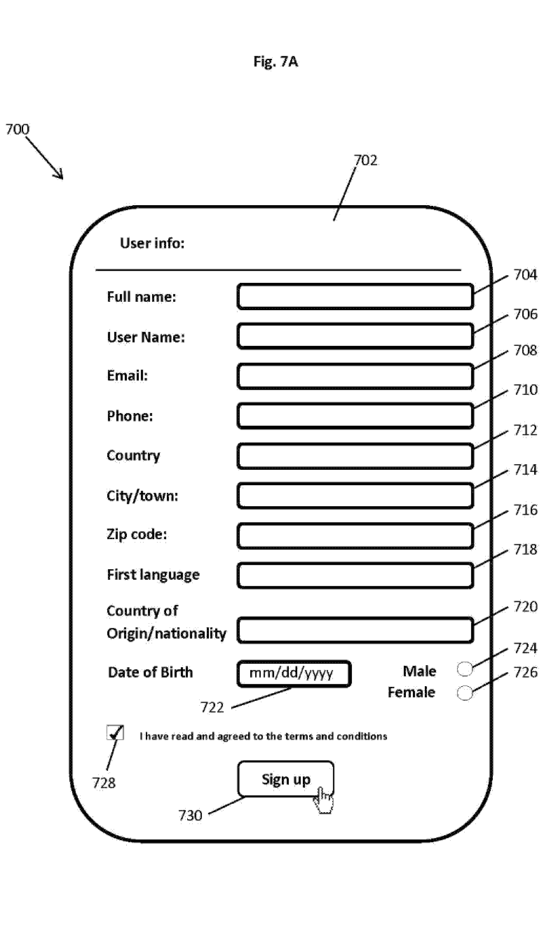

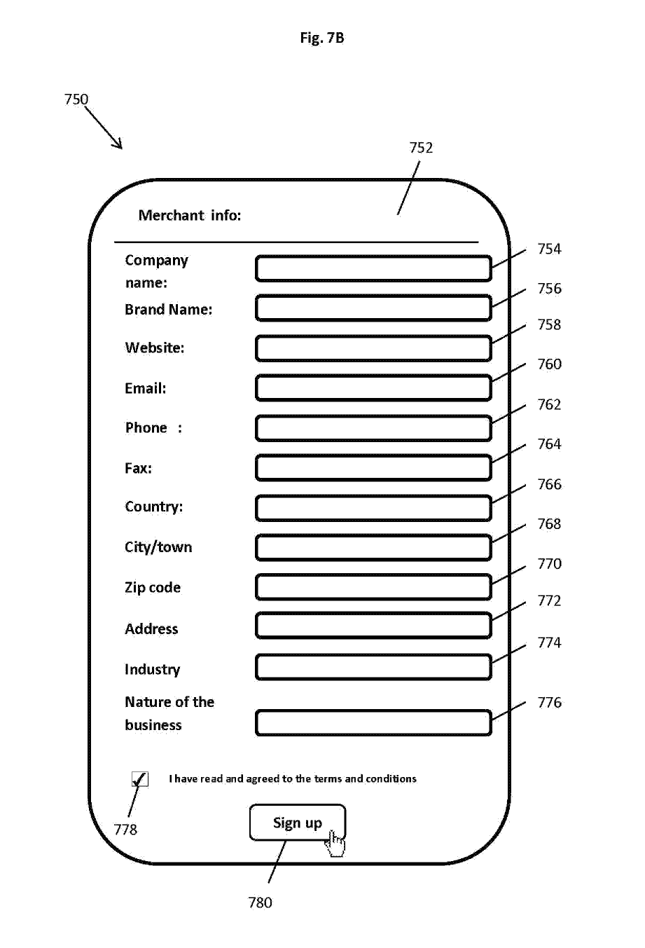

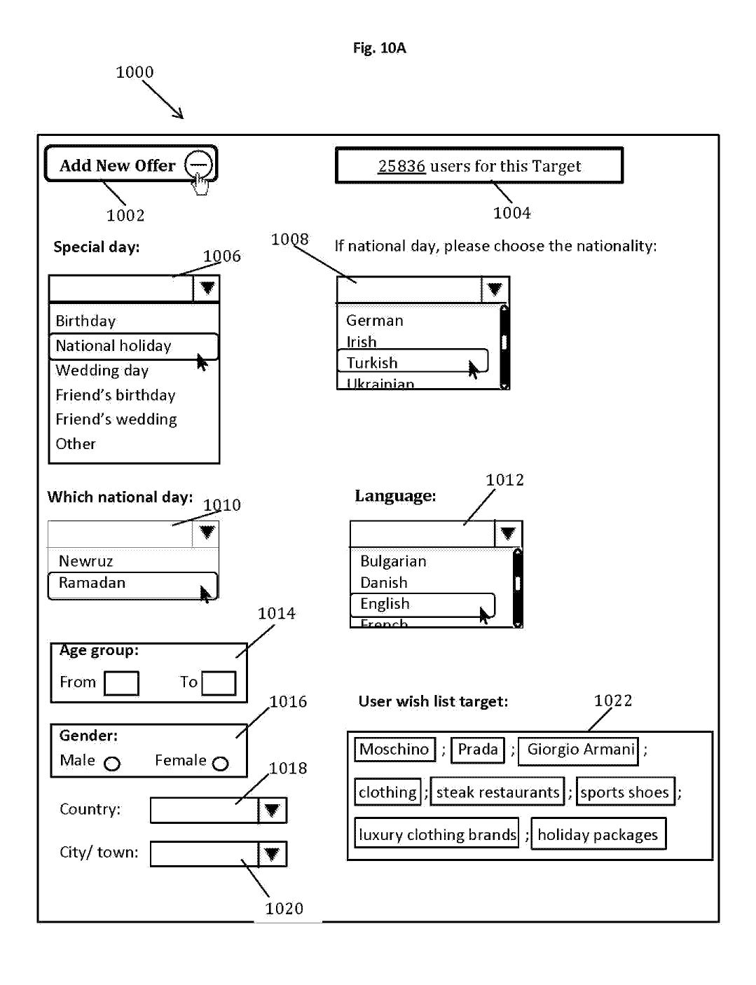

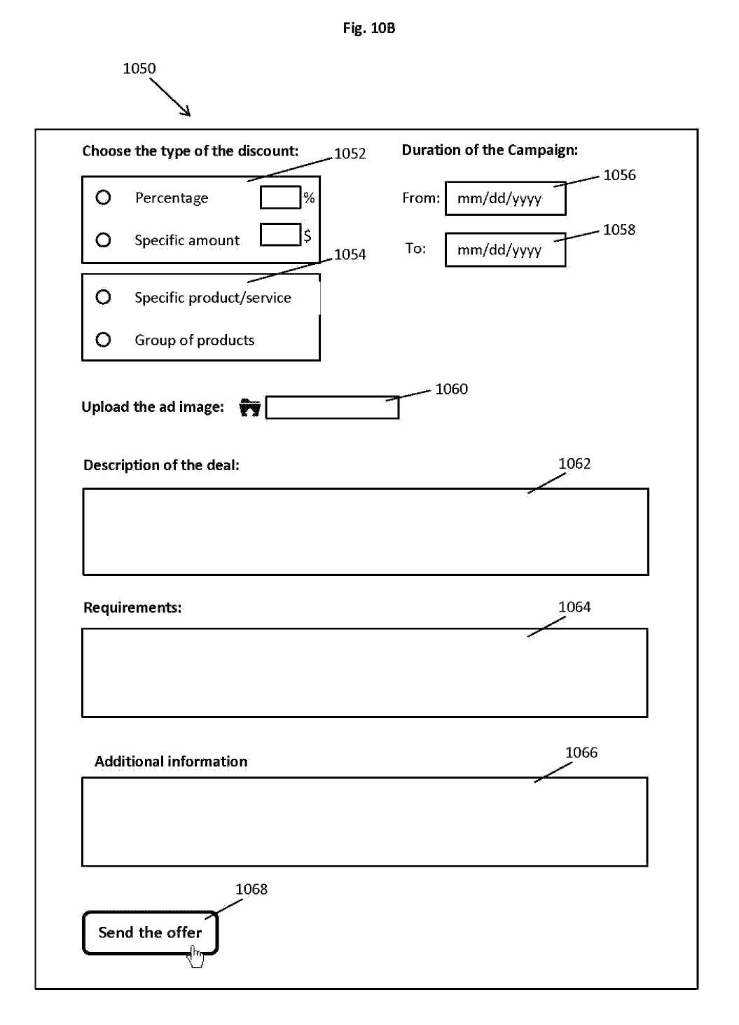

FIG. 5 is a block diagram 500 of an example process in accordance with an embodiment of the present invention of a merchant's deal preparation and management. The first step 502 in the process is merchants' sign up for a merchant account by accessing merchant client user interface 310 and/or any of its components, such as the merchant website 312a, merchant software/mobile application 312b, and merchant social media app 312c via any of the merchant programmable computing devices 122a -122x which then provides this information to application/web server 232, via internet 130; and the application/web server 232 sends this information to the database server 234 with the request of storing in the storage of the database server 234. A merchant may sign up by inputting their business details, such as name, location, address, contacts, nature of the business, and industry, through for example web page or image 750 shown in FIG. 7B. After signing up for their merchant account, a merchant may create a new offer in the offer preparation page 1000 as shown in FIG. 10A by clicking a “Add new offer” button 1002 in FIG. 10A, at step 504. In the offer preparation page 1000 of the promotional offer creator 322, merchants may choose the special day which they want to prepare an offer for through section or field 1006 and the other targets such as language through section 1012, age group through section 1014, gender through section 1016, location through sections 1018 and 1020 and wish list tags and/or keywords through section 1022 through merchant client user interface 310, and its components 312a, 312b, and/or 312c via any of the merchant programmable computing devices 122a to 122x at step 506.

Merchants may then select the number of days or a date range through sections 1056 and 1058 of FIG. 10B, they want the campaign to continue at step 508, and input the number via merchant client user interface 310, and its components 312a, 312b, and 312c provided by the application/web server via any of the merchant programmable computing devices 122a to 122x. As a merchant chooses targets through sections 1012, 1014, 1016, 1016, 1018, 1020 and 1022 , special days through section 1006 and 1008 of FIG. 10A and campaign period through sections 1056 and 1058 of FIG. 10B, the application/web server 234 updates the web page or the software application page on the merchant client user interface 310, and/or its components 312a, 312b, and 312c to show and/or display merchants 302 via any of the merchant programmable computing devices 122a-122x how many people exist, as shown in section 1004 of image 1000 of FIG. 10A, in the server computer memory 142 or database server 234 for those targets on each of the chosen days at step 510. For example, when they choose wedding anniversary as a special day category, the application/web server 234 updates the web page or the software application page on the merchant client user interface 310, and/or its components 312a, 312b, and 312c to show how many people, such as through section 1004 of FIG. 10A, have specified their wedding anniversary date in the server computer memory 142 or database server 234 and how many users' wedding anniversary date coincide with the period that a merchant specified as the campaign's continuation period.

At the step 512 merchants may choose a type of the offer and fill the boxes of image 1050 in FIG. 10B which are related to the chosen type of a deal. One type of a deal can be a discount on total price of a purchase such as specific money cut for all products/services or group of products/services, or specific percentage discount for all products/services or group of products/service. Another type of a deal can be a product/order based discount offer, such as a discount just for a specific product or service. The merchants may include any content and pictures at step 512.

After a merchant clicks and/or selects a “send offer” button 1068 shown in FIG. 10B, newly created offers may go onto a waiting list which is stored in computer memory of the server computer 230, staying inactive, with an indication that they are inactive, until these offers get approved by the server 230 in accordance with a computer program stored in the storage of the application/web server 234, as shown in 514.

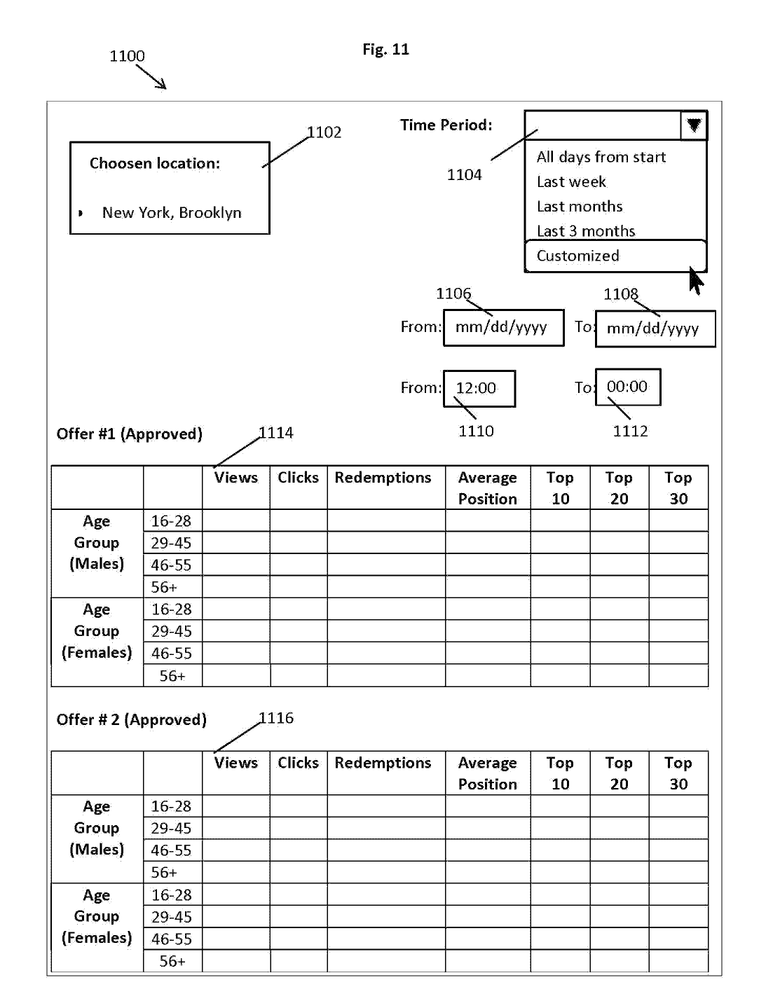

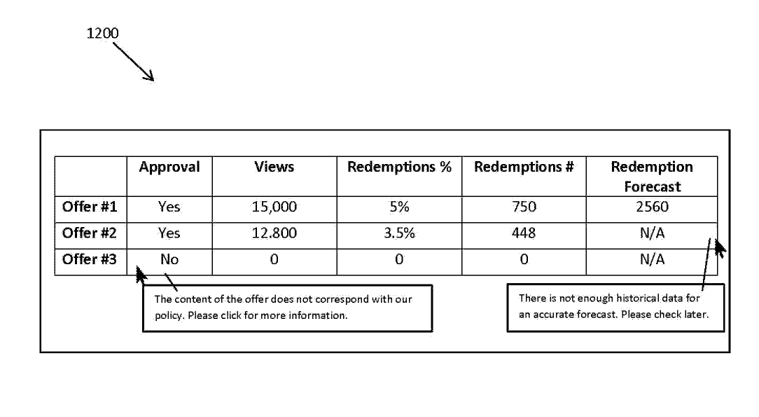

Report center 516 may be computer software programmed in the application/web server 232, and implemented by the application/web server 232 using the stored data in the database server 234. Application/web server 232 is programmed to send a requests to the database server 234 according to merchants' data reporting requests made via merchant client user interface 310 and/or any of its components, such as the merchant website 312a, merchant software/mobile application 312b, and merchant social media app 312c using any of the merchant programmable computing devices 122a to 122x and the application/web server 232 gets responses relevant to its requests. These requests may be for providing statistical information of promotional deal redemptions made by users 202, number of impressions/views of offered promotional deals by users, number of clicks on a promotional deal impressions by users, average place of offered promotional deals in the list etc., and breakdown of that information according to users' gender, age, location, interests etc. as shown in FIGS. 11 and 12. The database server 234 is programmed by computer software to respond to these requests, which are made by the application/Web server 232, by analyzing and synthesizing the stored data which is collected on a regular basis by installed computer software into the application/web server 232 by tracking the behavior of the users related to the active promotional offers, which are shown to users 202 via client user interfaces 210 and/or 212a, 212b, 212c using any of the user programmable computing devices 112a to 112x, and sending the user behavioral information back to the database store.

Merchants can also see historical data of number of redemptions, impressions/views, clicks, and average position of a deal in deal lists, based on days, months and hours. Merchants 302 may also request a report of the number of times the deal has appeared among top ten, top twenty, top thirty etc. deals when users 202 view the list as shown in FIG. 11. This information allows merchants to optimize their deals' targets and/or effectiveness in order to be in a better or upper position in the deal lists.

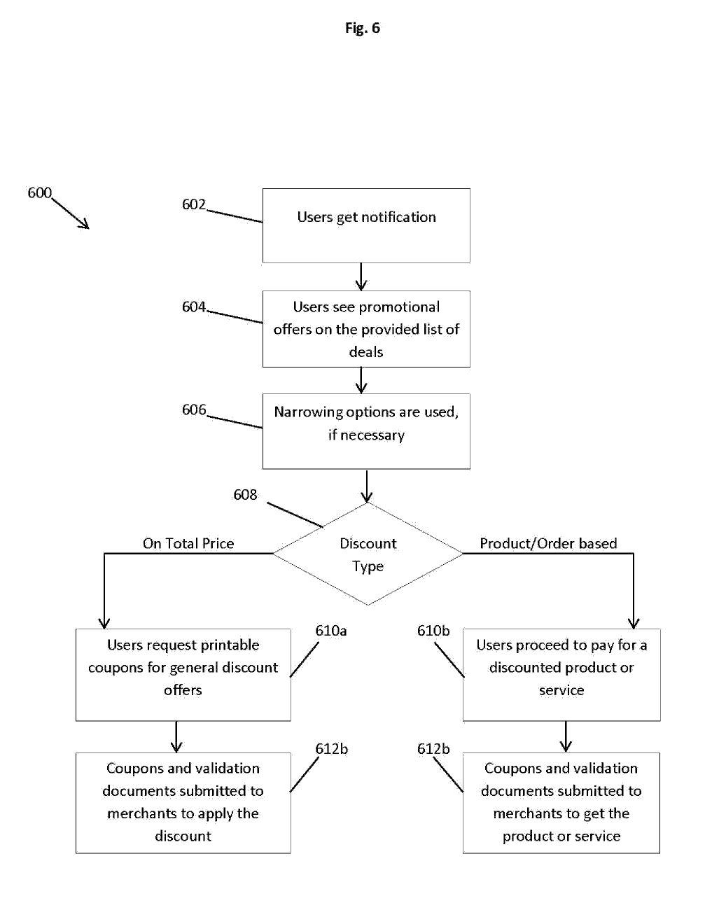

FIG. 6 is a block diagram 600 of an example process of users' deal redemption. Users get notifications via downloaded computer and/or mobile software application, social media software application, email or SMS (short message servicing text) at step 602. Users may click on the notification itself, using the user programmable computing devices 112a-112x, or the URL link in the notification, which causes the server computer 230 or application/webserver 232 to send a web page to the user programmable computing devices 112a to 112x through an internet web browser via internet 130, which may be a page of deals list at step 604. Users may scroll up and down on the web and/or software page provided by the application server 230, using the input/pointing device of a user programmable computing devices 112a to 112x to see all deals on the display screen of a user programmable computing device 112a to 112x, and narrow the list by ticking or selecting the narrowing options provided by the application/web server 232 as shown by page or image 900 in FIG. 9 (discount types, different industries etc.) 606. There may be two directions, in at least one embodiment, after this stage depending on the type of a discount a user is redeeming 608. If the discount type is on total price such as specific money cut for all products or specific percentage discount for all products, then a user may click on the offer, or the image of the offer on a web page or software page, provided by the application/web server 232, displayed on the user programmable computing devices 112a-112x, if they are interested in to select. If the user wants, the user may request a printable coupon for the offer in order to print at step 610a. Then users submit their printed coupons, if required, via any validation means to merchants (e.g. ID, other documents etc.) while purchasing in order to get the offered discount at step 610a.

In at least one embodiment, if the discount is a product/order based discount offer, such as a discount just for a specific product or service, users may click on the offer or the image of the offer they are interested in, to select on a web page or software page, provided by the application/web server 232, displayed on the user programmable computing devices 112a-112x, and they may proceed to pay for the coupon of the offer in order to print at step 610b. Users may pay online for this type of discount. After this step, they may submit their coupons to merchants (e.g. ID, other documents etc.) in order to get the product or service at step 612b. If delivery is available, then the users may get their product delivered to their door.

FIG. 7A shows a user registration web page or image 700 displayed on a computer display of a user computer, such as a user computer smart phone, tablet or personal computer, such as one of devices 112a-x, in accordance with one or more embodiments of the present invention. The page or image 700 includes user info 702, which also includes entry fields, boxes, or buttons 704, 706, 708, 710, 712, 714, 716, 718, 720, 722, 724, 726, 728, and 730. User's personal information 702, corresponding to the text to the left of fields 704-722 can be entered into one of devices 112a-x through image or page 702 by using a computer interactive device, such as a touchscreen, computer mouse, or keyboard. The fields or circular buttons 724 and 726 can be selected or checked to indicate if the person is a male or female. The field 728 can be checked to indicate that the particular person has seen and has agreed to conditions of the web site. The field or button 730 can be selected to cause the appropriate device of devices 112a-x to register the particular person with the server computer 230, such as including saving the user information 702 provided through page 700 in computer memory of server computer 230.

FIG. 7B shows a merchant registration web page or image 750 displayed on a computer display of a merchant computer, such as a merchant computer smart phone, tablet or merchant personal computer, such as one of devices 122a-x of FIG. 1, in accordance with one or more embodiments of the present invention. The page or image 750 includes merchant info 752 which also includes entry fields, boxes, or buttons 754, 756, 758, 760, 762, 764, 766, 768, 770, 772, 774, 776, 778, and 780. Merchant information 752, corresponding to the text to the left of fields 754-776 can be entered into one of devices 122a-x through image or page 750 by using a computer interactive device, such as a touchscreen, computer mouse, or keyboard. The field 778 can be checked to indicate that the particular merchant has seen and has agreed to conditions of the web site. The field or button 780 can be selected to cause the appropriate device of devices 122a-x to register the particular merchant with the server computer 230, such as including saving the merchant information 752 provided through page 750 to computer memory in server computer 230.

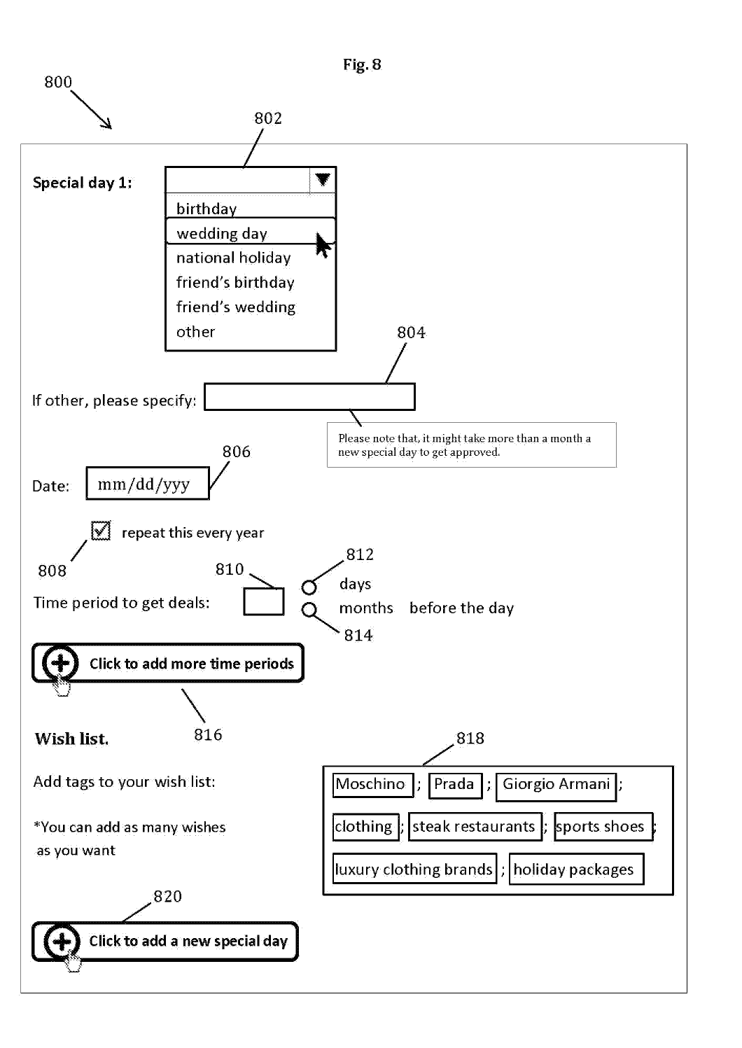

FIG. 8 shows a user's special day inputting page, web page, or image 800 which may be displayed on a computer display of a user computer, such as one or more of devices 112a-x in accordance with one or more embodiments of the present invention. The page 800 includes a section 802 for selecting a predetermined special day from a drop down menu. The page 800 also includes an entry field 804 for inputting a special day into one or more of devices 112a-x, which will then be sent to the server computer 230 and stored in computer memory of the server computer 230.

The page 800 further includes a field 806 for entering a date of the special day entered in field 804. The page 800 further includes a field or box 808 which can be checked to indicate that the notifications for the special day of field 804 should be repeated every year. The page 800 further includes a field 810 into which a number can be entered to indicate a number of days or months before the special day that notifications are desired. Field 812 can be checked to indicate days and field 814 can be checked to indicate months.

The page 800 further includes field 816 which can be selected to add one or more time periods for receiving notifications of promotional deals or other information before a particular special day. A user can enter one or more tags which may include brand names and/or industry into the wish list box or field 818 in order to indicate what type of deals and/or from which brands they want get deals. These tags are their preference of deals which creates another targeting tool for merchants. Based on their wish list 818, merchants may target the customers in order to be in higher and more visible place in the deals page shown in 906 in FIG. 9.

The page 800 further includes field or box 820 which can be selected to add a new special day. When a user selects the field or box 820 a new page is displayed which comprises the same elements shown in 800 and allows creating a new special day in the same order. In this way, users, may add different special days into their profile such as wedding day, national day, friend's birthday etc. in order to get deals in relation to those days.

FIG. 9 shows a page, web page, or image 900 which can be displayed on a user computer display of a user device of devices 112a-x. The image 900 includes a section 902 which lists a plurality of industries with a plurality of corresponding boxes or fields which can be selected using a computer interactive device of devices 112a-x. For example, “Restaurants”, “Clothing Brands” and “Health and Beauty” have been selected in image 900. The image 900 also includes a section 904 of the types of discounts a user wants to view.

The section 904 includes a plurality of boxes or fields each of which can be checked to view information on the corresponding discount. The image 900 also includes section 906 which may be a plurality of promotional deals from merchants.

FIG. 10A shows a merchant promotional offer creator page, web page, or image 1000 displayed on a computer display of a merchant computer, such as one or more of devices 122a-x. The image 1000 includes fields, buttons, or sections 1002, 1004, 1006, 1008, 1010, 1012, 1014, 1016, 1018, 1020, and 1022. Button 1002 can be selected by a merchant using a merchant computer interactive device of one or more of devices 122a-x to add a new offer which is sent to and may be stored in computer memory of the server computer 230.

The field 1004 displays the number of users to which this particular merchant may potentially send its offers/promotional deals based on its selection of targets 1006, 1008, 1010, 1012, 1014, 1016, 1018, 1020 and 1022. The section 1006 is a drop down menu, through which a merchant can select a special day to target for a promotional offer. The section 1008 is a drop down menu for selecting the nationality or ethnicity for a particular national day. In at least one embodiment, the section 1008 appears only when merchants target national days in the section 1006. The section 1010 allows selection of national day. In at least one embodiment, it also appears only when merchants target national days in the section 1006. The section 1012 allows selection of a particular language in which a merchant or merchants want to send their offer/promotional deals to the users whose first language is this particular language. The section 1014 allows a merchant to select an age group from one age to another age for targeting the particular age group of users. The section 1016, allows the merchant to limit targeting to male or female. In at least one embodiment, a merchant may not select any of the options in the section 1016 if they target both genders. The section 1018 allows a country to be selected and targeted. The section 1020 allows a city/town to be selected and targeted for a promotion. The section 1022 allows a plurality of wish list targets to be input by a merchant to target the interest of users. These targeting tools allow the system to determine the order of a deals list 906 in FIG. 9 for each user, when they view them. It means that, more accurately targeted deals will be shown in higher positions than less accurately targeted deals. Special day targeting and location targeting are considered main targets since the deals may be limited to only one special day and specific locations. The other targeting options are considered sub-targets. Deals that are not relevant to a special day and location of a user will not be shown to the user. However, a user, which is not under sub-targets of different merchants, will be able to see the deals from those particular merchants on their deals list 906 in FIG. 9, but in a lower position than the deals from merchants which more accurately targeted that particular user. All sub-targets may also be considered as a main target, if a deal relates to one category of sub-target only (e.g. for a cosmetics deal, gender target is considered main target, and the deal will be sent/shown to females only)

FIG. 10B shows a second page, web page, or image 1050 of a merchant promotional offer creator page displayed on a computer display of a merchant computer, such as one of devices 122a-x in accordance with one or more embodiments of the present invention. The image 1050 includes sections 1052, 1054, 1056, 1058, 1060, 1062, 1064, 1066,1068. Section 1052 includes entry fields for entering a percentage discount and/or a specific dollar amount discount that a merchant wants to offer. Circular fields in the section 1052 allow selection of either the percentage or dollar discount offer.

Section 1054 includes circular fields which can be selected to apply discounts to a specific product or service or entire range or group of products which is called “group of products”.

Section 1056 allows entry into one or more of devices 122a-x of a start date for a promotion. Section 1058 allows entry into one or more of devices 122a-x of an end date for a promotion. Section 1060 allows entry of a file name having an image which can be uploaded to the server computer 230 and stored in computer memory of the server computer. Section 1062 allows entry of text for descriptive information, section 1064 allows entry of text for requirements of a merchant such as submitting ID or other proofs for a special day, or a requirement about the form of a voucher (e.g. “the voucher should be printed”) or any other requirements, and section 1066 allows entry of text for additional information related to a particular promotional campaign. Section 1068 is a field or button which can be selected to send the offer out to one or more of the user devices 112a-x.

FIG. 11 shows an example of a merchant report center page, web page, or image 1100 displayed on a computer display of a merchant computer, such as one of devices 122a-x, in accordance with one or more embodiments of the present invention. The web page or image 1100 includes sections 1102, 1104, 1106, 1108, 1110, 1112, 1114, and 1116.

Section 1102 specifies the chosen location of users which the report is based on. Section 1104, is a pull down menu which allows selection of a time period for a merchant report. If “customized” is chosen from the list in section 1104, a merchant may choose a start date 1106 and an end date 1108 for a merchant report. Section 1110 shows a start time for a merchant report and section 1112 shows an end time for a merchant report. Section 1114 shows a table of results for a promotional “Offer #1”. The table is broken down by age and gender, and shows number of views and clicks by users in user devices 112a-x, via client user interfaces 210 and/or 212a, 212b, 212c, as well as redemptions by users and average position on deals lists 906 in FIG. 9 shown to users in user devices 112a-x, via client user interfaces 210 and/or 212a, 212b, 212c. It also shows how many times the offer appeared in Top 10, Top 20 and Top 30 deals/offers on deal lists 906 in FIG. 9. The order of the deals may mainly be based on the accurateness of targeting used for a particular deal/offer.

Section 1116 shows a table for promotional “Offer #2” which is broken down into identical categories as table 1114, but for “Offer #2” instead of “Offer #1”.

FIG. 12 shows an example of a merchant account statistics page, web page, or image 1200 displayed on a computer display of a merchant computer, such as one or more of devices 122a-x in accordance with one or more embodiments of the present invention. The page 1200 shows a table of various important statistics for various offers, including their approval, total views, redemptions in percentage and in numbers, and redemption forecast of an offer. Redemption forecast of an offer is based on other merchants' historical data of redemption with the similar targets. The application server 232 calculates the average of redemptions of similar merchants with similar targets for a specific time (e.g. 3 months) and provides redemption forecast for other merchants when they create new deals. The redemption forecast becomes more optimized time to time based on a particular merchant's own historical data after using the system for certain period. The application server optimizes the previous forecast by comparing and calculating the average of other similar merchants' and the particular merchant's own historical data about redemptions. This statistics allows merchants to optimize their offers and their targeting in order to offer better quality deals.

There are numerous features, advantages and solutions of one or more embodiments of the present invention and they include the following:

One or more embodiments of the present invention create a centralized database for merchants to send their special day based offers to the right people in the right time, without using any other media platforms to advertise or announce their offer.

One or more embodiments of the present invention provides the merchants with the opportunity of sending promotional offers based on a valid reason (based on special occasions). In previous existing deal platforms, such as daily deal websites, merchants offer discounts for no reason.

Since one or more embodiments of the present invention provide merchants with valid reasons to offer discounts or other types of promotional deals, merchants do not face the risk of losing or weakening their brand image.

Merchants can put their requirements on the offer (such as identification card or marriage certificate etc.) by which they can control if they offered to a right person or not (which again helps them protect their high brand image).

Users or customers get notified, in at least one embodiment of the present invention by computer software applications (app) notifications or emails and sometimes SMSs (text messages).

One or more embodiments of the present invention do not cover only a specific special occasion such as birthday or marriage, it covers many and potentially virtually all of them including upcoming marriage or engagement dates, national holidays of different nations as well as the special days of friends (such as friends' birthday or wedding).

One or more embodiments of the present invention provide high targeted promotional deals based on people's location (city/town/zip code), age, gender, language etc.

One or more embodiments of the present invention allow merchants to give general discounts on the total shopping or on the shopping of a specific category (for example, a brand offers 30% discount on suits), in previous existing deal platforms, such as daily deal websites, merchants could only offer discounts based on specific product or service.

One or more embodiments of the present invention allow merchants to send personal offers to different nationalities living in the country based on their own holidays/celebration on which they are more likely to buy something. This feature allows the merchants to provide additional service by showing their attention to their current and potential customers.

In at least one embodiment of the present invention, a point based system creates a competition among the merchants to send better offers to higher level users, since those users are more likely to use those offers.

In at least one embodiment of the present invention, people can create their wish list that may contain exact name of brands, in order to get offers from them and realize their wish. One or more embodiments of the present invention allow users to include a product/service category or industry, from which they want to get offers, into their wish list. This feature allows the system to serve better quality deal offerings for users.

In at least one embodiment of the present invention, merchants can target users who are interested in their competitor brands by using wish list targeting.

In at least one embodiment of the present invention, merchants can get high quality reports which provide them with valuable marketing research data and which they can use when forming their own future business strategies.

Although the invention has been described by reference to particular illustrative embodiments thereof, many changes and modifications of the invention may become apparent to those skilled in the art without departing from the spirit and scope of the invention. It is therefore intended to include within this patent all such changes and modifications as may reasonably and properly be included within the scope of the present invention's contribution to the art.

I claim:

1. An apparatus comprising:
a server computer processor;
a server computer memory;
wherein the server computer processor is programmed by a computer program to:
collect user data from a plurality of users, concerning calendar dates which are special to one or more users ;
store the user data in the server computer memory;
and
provide merchant promotional deals to one or more users based on the user data.

2. The apparatus of claim 1 wherein
the merchant promotional deals are provided via a client user interface to one or more users.

3. The apparatus of claim 2 wherein
the users are notified about readiness of the merchant promotional deals by computer software application notifications which provide a link to a list of the merchant promotional deals.

4. The apparatus of claim 2 wherein
the users are notified about readiness of the merchant promotional deals by social media app notifications which provide a link to a list of the merchant promotional deals.

5. The apparatus of claim 2 wherein
the users are notified about readiness of the merchant promotional deals by email which provides a link to a list of the merchant promotional deals.

6. The apparatus of claim 2 wherein
the users are notified about readiness of the merchant promotional deals by, a short message service which provides a link to a list of the merchant promotional deals.

7. The apparatus of claim 4 wherein
the server computer processor is programmed to provide a menu of a plurality of different predetermined special events, and to receive a user selection of one or more of the plurality of predetermined special events;
and
wherein the server computer processor is programmed to provide merchant promotional deals to one or more users based on the users selection of one or more of the plurality of predetermined special events.

8. The apparatus of claim 1 wherein
the server computer processor provides merchant promotional deals as a list displayed on a computer display to a user, wherein the list is targeted to the user such that a first deal of the merchant promotional deals is more prominent in the list than a second deal of the merchant promotional deals, if the first deal more closely matches a set of personal data for the user.

9. The apparatus of claim 8 wherein
the first deal is more prominent in the list than the second deal by being higher in the list than the first deal.

10. A method comprising
collecting user data from a plurality of users, concerning calendar dates which are special to one or more user, using a server computer processor;
storing the user data in a server computer memory;
and
providing merchant promotional deals to one or more users based on the user data by use of the server computer processor;

11. The method of claim 10 wherein
the merchant promotional deals are provided by via by a client user interfaces to one or more users.

12. The method of claim 11 wherein
the users are notified about readiness of the merchant promotional deals by mobile communications computer software application notifications which provides a link to a list of merchant promotional deals.

13. The method of claim 11 wherein
the users are notified about readiness of the merchant promotional deals by social media application notifications which provide a link to a list of merchant promotional deals.

14. The method of claim 11 wherein
the users are notified about readiness of the merchant promotional deals by email which provides a link to a list of merchant promotional deals.

15. The method of claim 11 wherein
the users are notified about readiness of the merchant promotional deals by short message services which provide a link to a list of merchant promotional deals.

16. The method of claim 10 further comprising
providing a menu on a computer display, by user of a server computer processor, of a plurality of different predetermined special events,
receiving a user selection of one or more of the plurality of predetermined special events; and
providing one or more merchant promotional deals to one or more users based on the user selection of one or more of the plurality of predetermined special events.

17. A method comprising
preparing targeted merchant deals for a specific group of people using a computer processor based on user criteria.

18. The method of claim 17 wherein
the user criteria are age.

19. The method of claim 17 wherein
the user criteria are gender.

20. The method of claim 17 wherein
the user criteria are language.

21. The method of claim 17 wherein
the user criteria are nationality.

22. The method of claim 17 wherein
the user criteria are user's interests.
